(19) United States
(12) Patent Application Publication
(10) Pub. No.: US 2007/0000449 A1
(43) Pub. Date: Jan. 4, 2007

(54) Multiflap animal door

(76) Inventor: Fawn F. Martin, Kirkwood, MO (US)

Correspondence Address: HARNESS, DICKEY, & PIERCE, P.L.C, 7700 BONHOMME, STE 400, ST. LOUIS, MO, 63105, US

(21) Appl. No.: 11/170,236

(22) Filed: Jun. 29, 2005

(51) Int. Cl. A01K 1/03

(52) U.S. Cl. 119/484

(57) ABSTRACT

An animal door assembly includes a first flap having an opening and mountable for movement between an open position and a closed position. The animal door further includes a second flap that attaches to the first flap for movement between an open position and a closed position. The second flap covers the opening in the first flap when the second flap is in its closed position. The animal door can also be retrofitted to existing door assemblies.

### FIELD OF THE INVENTION

The present invention relates generally to animal doors including doors that accommodate animals of different size.

### BACKGROUND OF THE INVENTION

A variety of animal doors are known in the art that allow animals, such as dogs and cats, to enter and exit enclosures. Most of these animal doors consist of a frame mounted to a door and a flap that is pivotably attached to the frame so that an animal may simply push the flap to enter or exit the enclosure. In enclosures housing animals of different size, having such an animal door can present a problem. For example, if the flap is designed for a large dog, then a small dog will have difficulty pushing through the flap. Conversely, if the flap is designed for a small dog, then a large dog will have difficulty fitting through the animal door. For this reason, multiple animal doors are sometimes used, with each door sized to accommodate a particular animal. As recognized by the inventor, however, having such doors require additional materials, since, for example, multiple frames are needed. These additional materials require more labor during installation and may create an unattractive appearance.

### SUMMARY OF THE INVENTION

In order to solve these and other needs in the art, the inventor has succeeded at designing an animal door having more than one flap to accommodate animals of different size.

According to one aspect of the present invention, an animal door assembly includes a first flap having an opening and mountable for movement between an open position and a closed position. The animal door further includes a second flap attachable to the first flap for movement between an open position and a closed position. The second flap covers the opening in the first flap when the second flap is in its closed position.

In accordance with another aspect of the present invention, an animal door assembly includes a frame defining a first opening, and a first flap pivotably mountable to the frame for movement between an open position and a closed position. The first flap covers a portion of the first opening when the first flap is in its closed position. The first flap also defines a second opening. Further, the animal door includes a second flap pivotably mountable to one of the frame and the first flap for movement between an open position and a closed position. The second flap covers the second opening when the second flap is in its closed position.

In accordance with a further aspect of the invention, a method of retrofitting an animal door to accommodate animals of different size having a first flap includes forming an opening in the first flap, and mounting a second flap for movement between an open position and a closed position with the second flap covering the opening in the first flap when the second flap is in its closed position.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an animal door according to one embodiment of the present invention.

FIG. 2 is a side view of the door of FIG. 1 illustrating movement of a first flap and a second flap between open and closed positions.

FIG. 3 is a perspective view of an animal door according to another embodiment of the present invention.

FIG. 4a is a perspective view of a panel for securing the flaps of FIG. 3.

FIG. 4b is a perspective view of a panel having a track according to another embodiment of the invention.

FIG. 4c is a perspective view of a panel for securing the second flap of FIG. 3 in a closed position.

### DETAILED DESCRIPTION OF EXEMPLARY EMBODIMENTS

The following description of exemplary embodiments is in no way intended to limit the invention, its application, or uses. Further, since the description of the invention is merely exemplary in nature, variations that do not depart from the gist of the invention are intended to be within the scope of the invention. Such variations are not to be regarded as a departure from the spirit and scope of the invention.

An animal door according to one exemplary embodiment of the present invention is illustrated in FIG. 1 and indicated generally by reference 100. As shown in FIG. 1, the animal door 100 includes a first flap 102, and a second flap 104. First flap 102 includes an opening 106 and can be mounted for movement between an open position (as shown in FIG. 1) and a closed position. Second flap 104 covers opening 106 when second flap 104 is in its closed position.

Animal door 100 may include a hinge 108 for pivotably attaching second flap 104 to first flap 102. Alternatively, conventional or other means of attaching second flap 104 to first flap 102 may be used.

Furthermore, animal door 100 may include weather seals 110 to prevent drafts and other debris from entering an enclosure as further described below.

It should be understood that the animal door of FIG. 1 may be installed in any suitable opening using conventional or other means. The animal door may include a frame (not shown in FIG. 1) for this purpose. The animal door may also be retrofitted to existing animal door assemblies as further described below.

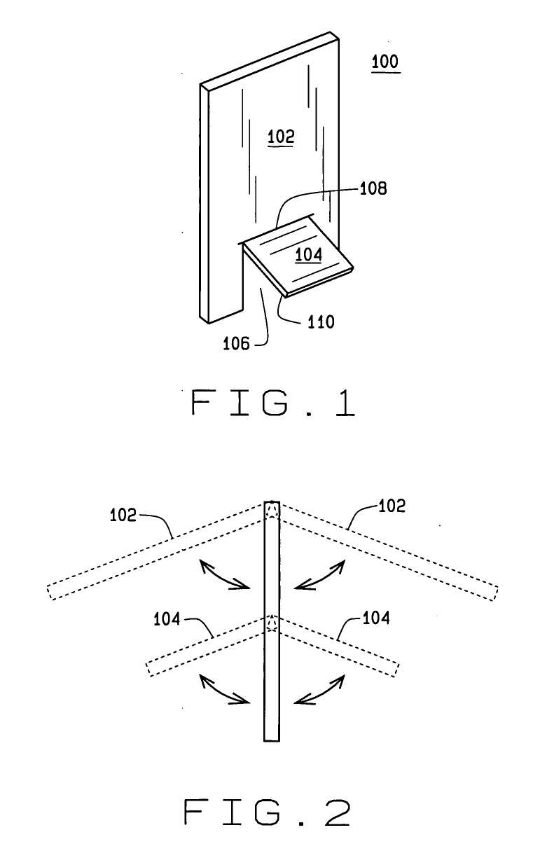

FIG. 2 further illustrates movement of first flap 102 and second flap 104 from a closed position to an open position for animals entering and exiting an enclosure. Larger animals are able to pass through first flap 102 while smaller animals in the same enclosure are able to pass through second flap 104.

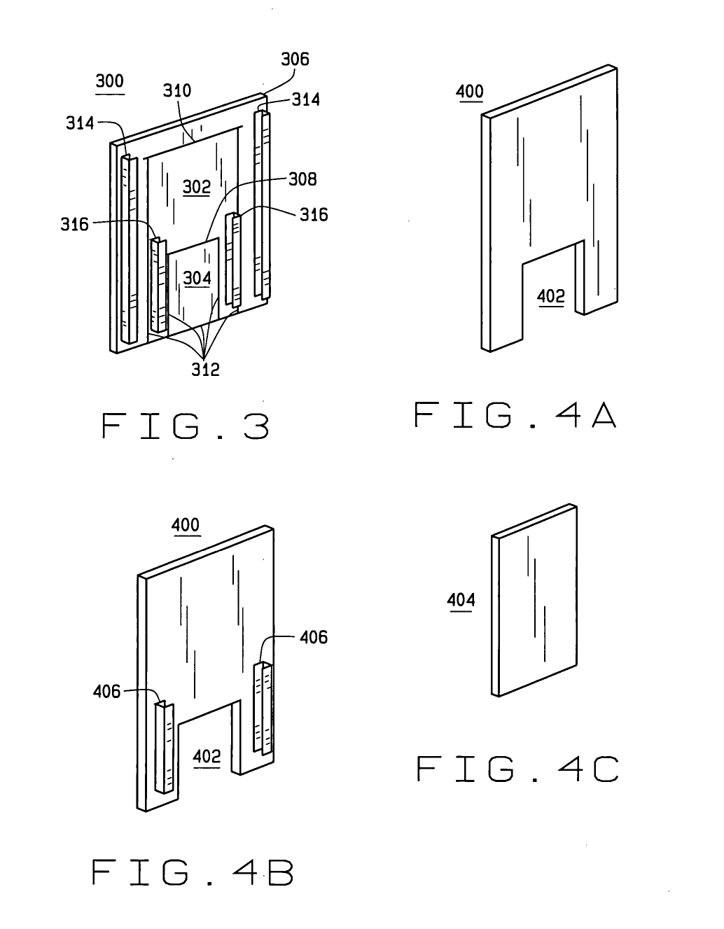

An animal door according to another exemplary embodiment of the present invention is illustrated in FIG. 3 and indicated generally by reference 300. As shown in FIG. 3, animal door 300 includes a frame 306 that defines an opening. This embodiment also includes a first flap 302 positioned in such opening, and a second flap 304. First flap 302 defines another opening and is attached to the frame 306 as indicated by a hinge 310, or by other means. In addition, second flap 304 is attached to first flap 302 by a hinge 308, or by other means.

Hinges 310 and 308 allow flaps 302 and 304 to move pivotably between an open position and a closed position (as shown in FIG. 3). First flap 302 covers a portion of the opening defined by the frame 306 when first flap 302 is in its closed position. Second flap 304 covers the opening defined by first flap 302 when second flap 304 is in its closed position.

The opening defined by first flap 302 may be located anywhere on flap 302 and is preferably smaller than the opening defined by frame 306. Alternatively, second flap 304 could be attached to frame 306.

First flap 302 and second flap 304 may be lined with weather seals 312 (also shown in FIG. 1 by weather seals 110) to prevent drafts and other debris from entering an enclosure when first flap 302 and second flap 304 are in their closed positions. Weather seals 312 may serve the additional purpose of restricting the movement of second flap 304 when an animal pushes first flap 302 so that second flap 304 remains in its closed position. Such weather seals can be brushes or magnetic strips, or be made from a variety of materials including high-density nylon pile or rubber.

A panel 400, illustrated in FIG. 4a, is provided for securing first flap 302 in its closed position. Panel 400 is intended to prevent an animal that uses first flap 302 (i.e. the larger animal) from entering or exiting an enclosure. Panel 400 includes an opening 402 which allows movement of the second flap 304 between its open and closed positions. Panel 400 is secured to the animal door by track 314, illustrated in FIG. 3. Track 314 is attached to frame 306 and slidably receives panel 400. Another track, 316, is preferably attached to first flap 302 to secure another panel, 404, illustrated in FIG. 4c, to the animal door. Panel 404 is intended to prevent the animal that uses second flap 304 (i.e. the smaller animal) from entering or exiting an enclosure. Alternatively, instead of track 316, another track, 406, may be attached to panel 400 as shown in FIG. 4b.

The use of panel 404 in combination with panel 400 allows a user several options in deciding which animal (i.e. the larger, smaller, or both) to keep outside or inside the enclosure. For example, if the user wants the large animal to pass through the animal door, but would like to prevent the small animal from doing so, then the user would slide panel 404 through track 316. Alternatively, if the user wants the small animal to pass through the animal door, but would like to prevent the large animal from doing so, then the user would slide panel 400 through track 314. In another alternative, if the user wants to prevent both animals from passing through the animal door, then the user would slide panel 400 through track 314 and slide panel 404 through track 316.

Panels 400 and 404 may be made from various materials such as steel, plastic, and others known in the art. Conversely, other devices, such as locks, can be used instead of panels 400 and 404 to secure first flap 302 and second flap 304 in their respective closed positions. Furthermore, instead of tracks 314 and 316, screws can be used to secure panels 400 and 404 to frame 306 and first flap 302 respectively.

Flaps 102, 104, 302, and 304 can be made from any material known in the art including aluminum, glass, vinyl, and PVC. Further, they can come in different colors, and be clear or opaque. Although, flaps 102, 104, 302, and 304 are depicted in FIGS. 1, 2, and 3 as single flat panels attached at one side, the present invention is not so limited. For example, other flaps could be used such as multiple flaps connected at reference 108 instead of second flap 104 to cover opening 106. Furthermore, panels, flexible or rigid, that are attached at more than one side, or even pieces with curved portions, could be used instead of flaps.

Frame 306 may include decorative trim or molding (not shown). A variety of frame configurations are known in the art and can be used as desired in any given application of the present invention.

The present invention is also not limited for domestic uses. Animals housed in a zoo, for example, could use an animal door embodied by the present invention. Such animal doors, however, would have to be made of stronger and more durable materials, since some animals in zoos, such as bears, tigers and lions are much larger and stronger than average domestic dogs and cats. Additionally, whether for use in domestic or nondomestic applications, the present invention is not limited to use on the doors of enclosures, but could also be used on windows and walls.

In view of the above, it will be seen that several aspects of the invention are achieved and other advantageous results attained. As various changes could be made in the above exemplary constructions and methods without departing from the scope of the invention, it is intended that all matter contained in the above description or shown in the accompanying drawings shall be interpreted as illustrative and not in a limiting sense.

It is further to be understood that the methods described herein are not to be construed as necessarily requiring their performance in the particular order discussed or illustrated. It is also to be understood that additional or alternative steps may be employed.

What is claimed is:

1. An animal door assembly comprising:
a first flap having an opening therein and mountable for movement between an open position and a closed position; and
a second flap attachable to the first flap for movement between an open position and a closed position, the second flap covering the opening in the first flap when the second flap is in its closed position.

2. The animal door of claim 1 wherein the second flap is pivotably attachable to the first flap.

3. The animal door of claim 1 further comprising a frame, wherein the first flap is pivotably attachable to the frame.

4. The animal door of claim 1 further comprising a first panel for selectively securing the first flap in its closed position.

5. The animal door of claim 4 wherein the first panel includes an opening therein, the first panel permitting movement of the second flap between its open and closed positions while selectively securing the first flap in its closed position.

6. The animal door of claim 4 further comprising a second panel for selectively securing the second flap in its closed position.

7. The animal door of claim 6 wherein the first panel includes a track for slidably receiving the second panel.

8. An animal door assembly comprising:
a frame defining a first opening;
a first flap pivotably mountable to the frame for movement between an open position and a closed position, the first flap covering a portion of the first opening when the first flap is in its closed position, the first flap defining a second opening; and
a second flap pivotably mountable to one of the frame and the first flap for movement between an open position and a closed position, the second flap covering the second opening when the second flap is in its closed position.

9. The animal door of claim 8 wherein the first opening is larger than the second opening.

10. The animal door of claim 9 wherein the second flap is pivotably mountable to the first flap.

11. The animal door of claim 9 further comprising a device for securing at least one of the first flap and the second flap in the closed position.

12. The animal door of claim 11 wherein the device is a panel for selectively inhibiting movement of the first flap from its closed position.

13. The animal door of claim 12 wherein the panel does not cover the second opening when the panel selectively inhibits movement of the first flap from its closed position.

14. The animal door of claim 12 wherein one of the frame and the first flap includes a track for slidably receiving the panel.

15. A method of retrofitting an animal door to accommodate animals of different size, the animal door including a first flap, the method comprising:
forming an opening in the first flap, and
mounting a second flap for movement between an open position and a closed position with the second flap covering the opening in the first flap when the second flap is in its closed position.

16. The method of claim 15 wherein mounting includes pivotably mounting the second flap to the first flap.

17. The method of claim 15 further comprising removing the first flap from a frame prior to forming the opening in the first flap.
